(19) United States
(12) Patent Application Publication
(10) Pub. No.: US 2007/0168445 A1
(43) Pub. Date: Jul. 19, 2007

(54) Method and apparatus for storing and retrieving conversations in an instant messaging system

(76) Inventors: Denise Marie Genty, Austin, TX (US); Shawn Patrick Mullen, Buda, TX (US); James Stanley Tesauro, Austin, TX (US)

Correspondence Address: IBM CORP (YA);C/O YEE & ASSOCIATES PC, P.O. BOX 802333, DALLAS, TX, 75380, US

(21) Appl. No.: 11/334,667

(22) Filed: Jan. 18, 2006

(51) Int. Cl. G06F 15/16

(52) U.S. Cl. 709/207

(57) ABSTRACT

A computer implemented method, apparatus, and computer usable program code to detect an indication that a conversation between users in an instant messaging system should be saved. Endpoints and keyword data are extracted from the conversation in response to detecting the indication. An abstract generating from the endpoints and keyword data. The conversation is stored in association with the abstract.

### BACKGROUND OF THE INVENTION

1. Field of the Invention

The present invention relates generally to an improved data processing system and in particular to a method and apparatus for processing data. Still more particularly, the present invention relates generally to a computer implemented method, apparatus and computer usable program code for storing conversations generated during an instant messaging session.

2. Description of the Related Art

Instant messaging is on online chat medium, allowing users to communicate with each other and collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users can view each other's availability and initiate a text conversation with colleagues or customers when a desired contact becomes available.

Typically, with instant messaging applications, communications between users are initiated by users selecting the name of the person with which they desire to communicate. Then, the users type messages in a dialog box in the window and press “send”. These messages appear instantly on the other selected recipient's computer.

Examples of instant messaging applications include SameTime, a product available from International Business Machines Corporation; MSN Messenger, a product available from Microsoft Corporation; Yahoo! Messenger, a product available from Yahoo! Inc.; and AOL Instant Messenger, a product available from American Online.

When using an instant messaging client, a user often will want to resume a conversation or session with another user concerning a particular topic. At that time, the user may not have known to save the information from a previous conversation on the same topic. The current solution is for an instant messaging application to automatically save the current work space before exiting a conversation or session with another user or set of users. The problem with this type of currently used solution is that when a user desires to restore or bring back a prior conversation, that user has to search through all of the saved conversations. The user may be able to search these by date and by the person or persons involved in the conversation.

Such a system is not very efficient if the user has conversations with the other person or persons on a daily basis over a long period of time. The user may not want to read through numerous auto saved conversations to find the desired one. In some cases, these conversations may number in the hundreds or thousands.

### SUMMARY OF THE INVENTION

The present invention provides a computer implemented method, apparatus, and computer usable program code to detect an indication that a conversation between users in an instant messaging system should be saved. Endpoints and keyword data are extracted from the conversation in response to detecting the indication. An abstract generating from the endpoints and keyword data. The conversation is stored in association with the abstract.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in accordance with an illustrative embodiment of the present invention;

FIG. 2 is a block diagram of a data processing system in accordance with an illustrative embodiment of the present invention;

FIG. 3 is a block diagram illustrating components used in an instant messaging system in accordance with an illustrative embodiment of the present invention; and

FIG. 4 is a diagram illustrating components used in an instant messaging system in accordance with a preferred embodiment of the present invention;

FIG. 5 is a diagram illustrating a conversation during an instant messaging system between users is depicted in accordance with illustrative embodiment of the present invention.

FIG. 6 is a diagram illustrating a list of past conversations in accordance with an illustrative embodiment of the present invention;

FIG. 7 is a flowchart of a process for extracting information from a conversation in accordance with an illustrative embodiment of the present invention;

FIG. 8 is a flowchart of a process for extracting keyword data from the text of a conversation in accordance with an illustrative embodiment of the present invention;

FIG. 9 is a flowchart of a process for presenting titles from prior conversations in accordance with an illustrative embodiment of the present invention; and

FIG. 10 is a flowchart of a process for identifying additional conversations for use in accordance with an illustrative embodiment of the present invention.

### DETAILED DESCRIPTION OF THE PREFERRED EMBODIMENT

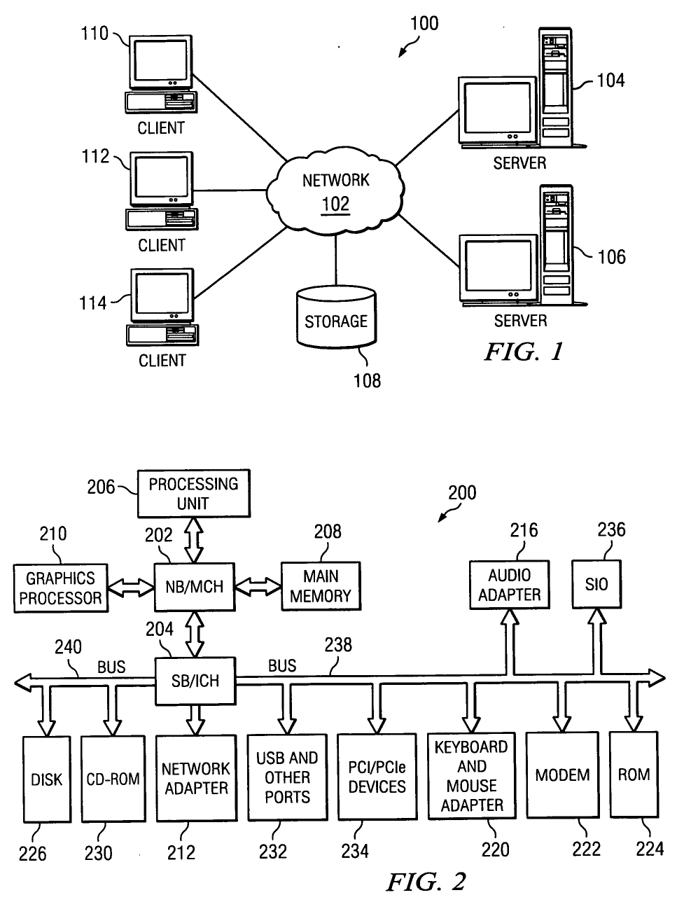

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer implemented method, apparatus, and computer usable program code for automatic naming and storage of conversations. Additionally, the aspects of the present invention also provide an ability to present these stored conversations in an efficient manner to reduce the time needed to find a desired one. The aspects of the present invention associate names of the people involved in each conversation as well as defining a meaningful title or abstract information for each conversation.

Further, the aspects of the present invention then present a meaningful list of conversations from which the user may select one. In particular, the aspects of the present invention identify end points. The end points are the users involved in each conversation. A chat session may have two or more users involved depending on the particular conversation. Additionally, the actual data from the conversation is used to derive an abstract, which may be keyword data or title data. Keyword data contain the end points and keywords from the conversation. Title data is a title that is generated using the end points and keywords from the conversation. A conversation is a set of messages sent between two or more users of an instant messaging system.

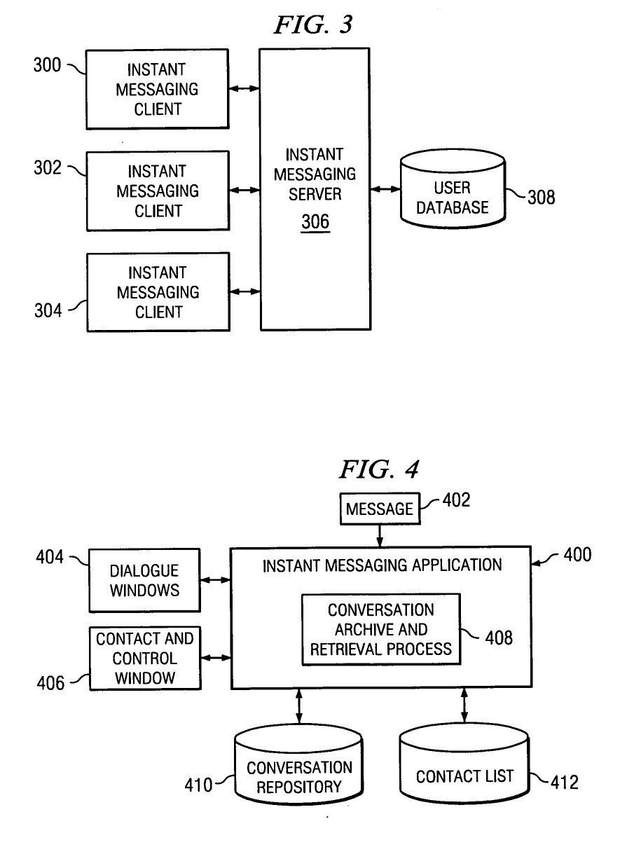

Turning now to FIG. 3, a block diagram illustrating components used in an instant messaging system is depicted in accordance with an illustrative embodiment of the present invention. In these examples, instant messaging clients 300, 302, and 304 connect to instant messaging server 306. These instant messaging clients may be executing on a data processing system, such as client 110 or client 112 in FIG. 1. Instant messaging server 306 may be executing on a data processing system, such as server 104 in FIG. 1.

Instant messaging client 300 may send or exchange messages with other users at instant messaging clients 302 and 304. Instant messaging server 306 facilitates the exchange of messages. This process allows for the users to find other users within the instant messaging system as well as aid in the exchange of messages between different users. The users for the instant messaging system are stored in user database 308. This database also is used to indicate which users are online when the particular user searches for another user through instant messaging server 306.

Depending on the particular instant messaging system, instant messaging server 306 only may be involved in providing an indication of when particular users are online are for establishing initial contacts while users contacting users already on a buddy list may contact those users directly after seeing that the particular user is online. The different users registered to the instant messaging system are stored in user database 306. This user database provides the information needed to search for and find other users as well as contact users when they are online.

Turning next to FIG. 4, a diagram illustrating components used in an instant messaging system is depicted in accordance with a preferred embodiment of the present invention.

In the depicted example, instant messaging application 400 processes messages, such as message 402 received from users located on remote data processing systems. As messages are received, these messages are presented in dialog windows 404. Messages exchanged between instant messaging application 400 and an instant messaging application on a remote data processing system form a conversation in these examples.

Additionally, dialog windows 404 provide an interface for user input to send messages to other users. Contact and control window 406 is presented by instant messaging application 400 to provide the user with a list of user names, as well as other information, such as, for example, identifying other users that are currently online. Contact and control window 406 also provides an interface to allow the user to set different preferences. For example, the user may set passwords required to access different names used in instant messaging sessions. Further, a user may employ contact and control window 406 to set other preferences, such as colors and fonts used in instant messaging application 400.

Also, the list of names presented by contact and control window 406 is stored in contact list 412 in these examples. Additional user names may be added or deleted from contact list 412. Contact list 412 is employed in presenting the list of names within contact and control window 406. Additionally, the user may view the status of other users using contact and control window 406. This status may be, for example, available or busy. When the status is available, instant messaging application 400 accepts messages from another instant messaging application to start a new conversation. When the status of another user is busy, messages from instant messaging application 400 are not accepted by the other application for that user.

In particular, instant messaging application 400 also includes conversation archive and retrieval process 408 in these examples. This process is used to save conversations in response to an event. The event may be, for example, the termination or closing of a window for a current conversation. Alternatively, this event may be one initiated by the user desiring to save a particular conversation. Conversations may be auto saved each time or through user input depending on the particular implementation. Further, the user may specify that conversations with certain other users are to be auto saved while others are not. The conversations are saved in conversation repository 410 in these examples.

In these illustrative examples, two methods may be implemented within conversation archive and retrieval process 408 to create indexing information that is presented to a user. One method is called TitleData extractTitleData (List endpoints, Data content). This method takes entities involved in the conversation and the actual data of the conversation to derive an abstract. The other method is String title (TitleData data, TitleParameters parms). This function takes the title data and formats, and places them into a string using format parameters in the title. In this manner, these two methods are used to generate titles that may be saved in association with a conversation.

When conversation archive and retrieval process 408 receives an indication that a conversation should be saved, this process identifies the end points for the conversation. Thus, if the conversation contains three users, three end points are present. The end points may be identified using, for example, the user name on a buddy list. Alternatively, the conversation name for the end point may be a shorted name of a user's email address. For example, “Jim” for a user name jim@company.com. Additionally, conversation archive and retrieval process 408 also parses through the data from the conversation as part of generating an abstract to create keyword data.

In one exemplary implementation, the process for extracting keyword data extracts some number of the most used technical terms and proper names in a conversation. These technical terms may come from a personal dictionary or a dictionary shared across a group of users depending on the particular implementation. The number of technical terms selected depends on the particular implementation. For example, a user may decide to set a preference to select the ten most used technical terms and proper names from the conversation.

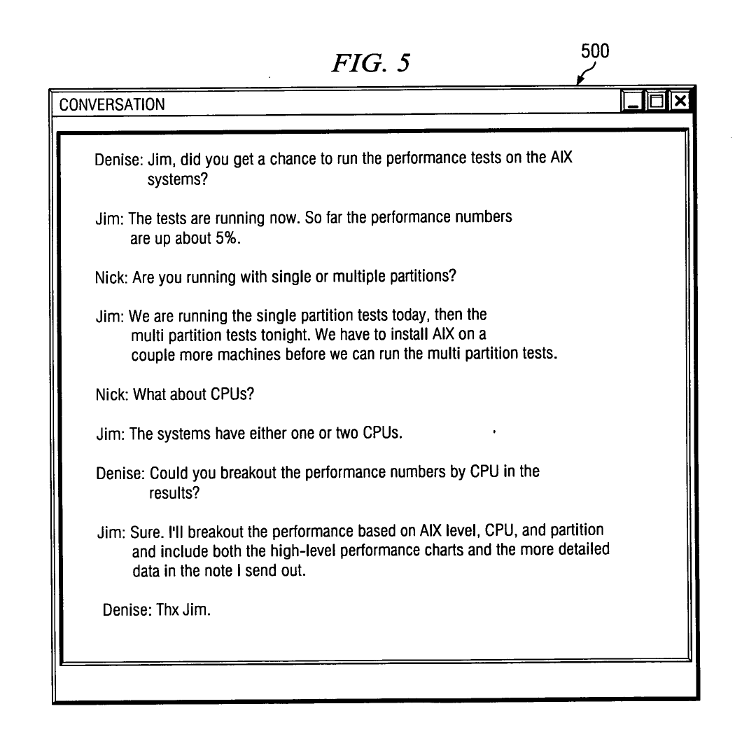

Turning to FIG. 5, a diagram illustrating a conversation during an instant messaging system between users is depicted in accordance with illustrative embodiment of the present invention. In this example, instant messaging window 500 illustrates a portion of a conversation between three users, Denise, Jim, and Nick. As a result, in exemplary conversation with Denise, Nick, and Jim, a user mentions Partition twenty five times, AIX thirteen times, CPU ten times, and Performance eleven times, the entry would look like: People: Denise, Nick, Jim; Data: Partition(25), AIX(13), CPU(10), Performance(11). This data, the end points and keyword data, are saved in association with the conversation. The data and the end points are used to generate a title.

Depending on the implementation, the title or the keyword data with the end points may be saved. Saving the keyword data allows all of the end points for a different title to be generated depending on changes in user preferences. For example, a user may want to see the five most common terms used in one situation but only the two in another.

When a user starts a conversation with another user, conversation archive and retrieval process 408 in FIG. 4 determines whether the user is present as an end point. If the user is present as an end point, then each conversation containing that end point is presented to the user.

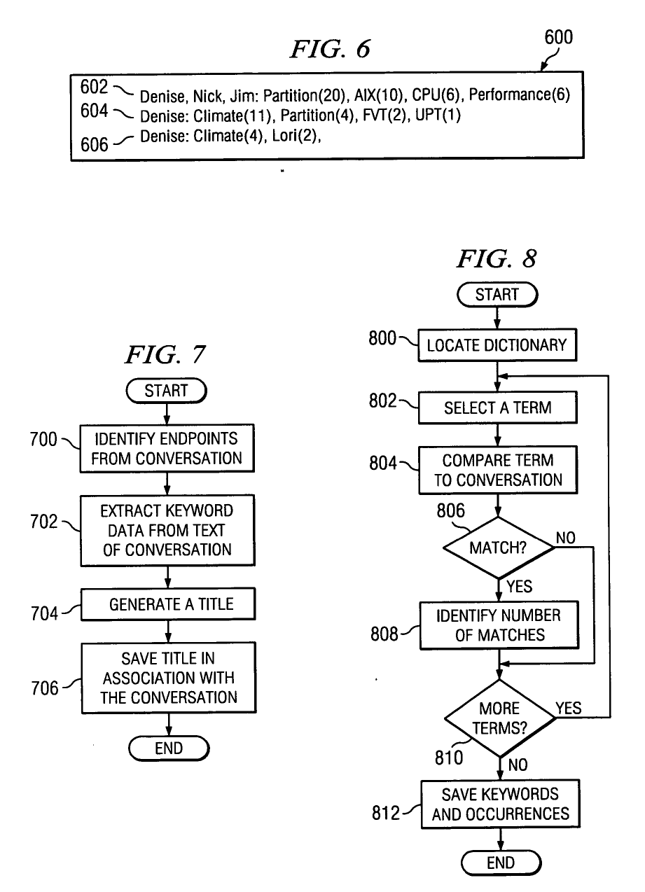

Turning now to FIG. 6, a diagram illustrating a list of past conversations is depicted in accordance with an illustrative embodiment of the present invention. In this example, window 600 contains three titles, title 602, title 604, and title 606. Each of these titles contains a list of end points and data. The keywords in the data list the number of times the keywords appear in the actual conversation. These keywords are derived from a personal or shared dictionary in these examples. A user may select one of these titles and have the conversation associated with the title placed in a window for viewing when initiating a new conversation.

Turning now to FIG. 7, a flowchart of a process for extracting information from a conversation is depicted in accordance with an illustrative embodiment of the present invention. The process illustrated in FIG. 7 may be implemented in a process, such as conversation archive and retrieval process 408 in instant messaging application 400 in FIG. 4.

The process begins by identifying end points from the conversation (step 700). These endpoints are the users that are involved in the conversation. The end points may take various forms depending on the implementation. For example, the end points may be a user name from a buddy list or an abbreviated form of an email address for the different participants. Thereafter, keyword data is extracted from the text of the conversation (step 702). This data may be extracted using a dictionary to identify the most used terms in the dictionary. These terms may be technical terms and/or proper names in the conversation as an example. Of course, the dictionary may contain any type of terms that the user is interested in for helping identify conversations.

Next, a title is generated to form the title data (step 704). In these examples, the title is a combination of the names or end points and the keyword data extracted from the abstract. The actual title generated may not include all of the keywords found in the search of the conversation. A user may designate that the title should include the five most used terms as an example. Then, the process saves the title in association with the conversation (step 706) with the process terminating thereafter. Depending on the particular implementation, the process may save the keyword data and end points extracted from the conversation and save this data in association with the conversation. In this manner, the type of title may change depending on user preferences. If a user wishes to see the two most common keywords in one instance rather than the five most common keywords, such returns can be easily made by the information in this manner.

Turning now to FIG. 8, a flowchart of a process for extracting keyword data from the text of a conversation is depicted in accordance with an illustrative embodiment of the present invention. The process illustrated in FIG. 8 is a more detailed description of step 702 in FIG. 7.

The process begins by locating a dictionary (step 800). This dictionary may be a personal dictionary created by the user or a shared dictionary used between different users. The dictionary also may be one that is provided with the instant messaging application. A term is selected from the dictionary (step 802). The term may be one or more words. The process then compares the term to the text in the conversation (step 804). A determination is made as to whether a match is present between the term and text in a conversation (step 806). If a match is present, the process identifies the number of matches (step 808). A determination is then made as to whether more terms are present for searching a new dictionary (step 810). If additional terms are present, the process returns to step 802 to select another term from the dictionary. Otherwise, the keywords and the number of the occurrences of these keywords are saved (step 812) with the process terminating thereafter.

With reference again to step 806, if a match is not present, the process proceeds to step 810 as described above.

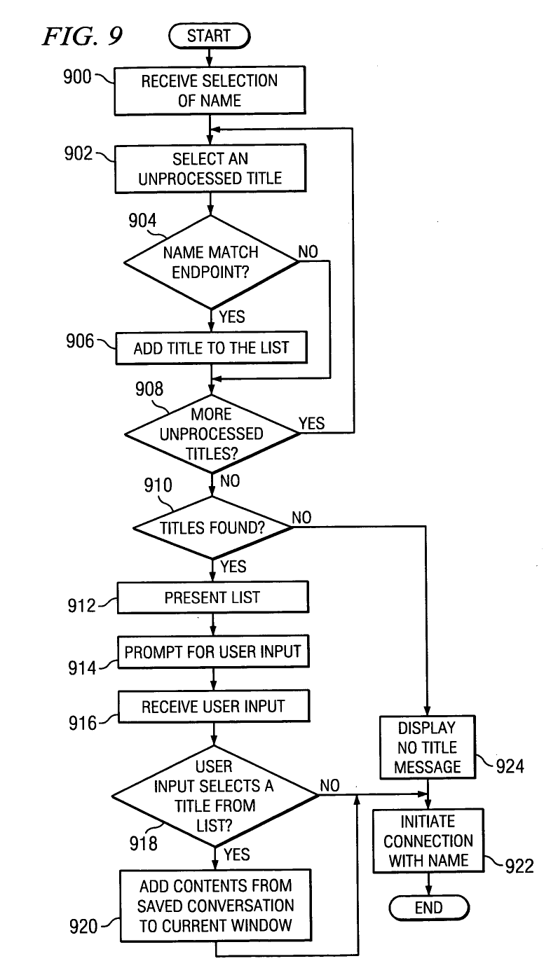

Turning now to FIG. 9, a flowchart of a process for presenting titles from prior conversations is depicted in accordance with an illustrative embodiment of the present invention. The process illustrated in FIG. 9 may be implemented in a process, such as conversation archive and retrieval process 408 in FIG. 4.

The process begins by receiving a selection of a name (step 900). In step 900, the selection of the name is the name of a user from a buddy list or other list of names to initiate a conversation. The process then selects interim process title (step 902). A determination is made as to whether an end point in the title matches the name selected in step 900 (step 904). If a match is present, the process adds the title to the list (step 906).

Then, a determination is made as to whether additional unprocessed titles are present (step 908). If additional unprocessed titles are present, the process returns to step 902. The process also proceeds to step 908 from step 904, if the name does not match an end point in the titles.

With reference again to step 908, if additional unprocessed titles are not present, all of the titles have then been processed. Thereafter, a determination is made as to whether any titles were found in the search (step 910). If one or more titles were found, the process presents the list of titles (step 912). Then, the process prompts the user for user input (step 914). This prompt may be, for example, a message indicating that the user may select a title from a list to retrieve the saved conversation.

Thereafter, the process receives user input (step 916). Then, a determination is made as to whether the user input selects a title from the list (step 918). The user may in some instances not wish to retrieve a prior conversation. If the user input selects a title from a list, the contents from a saved conversation associated with a title are placed in a current window (step 920).

Next, the connection is initiated with the name of the selected user (step 922) with the process terminating thereafter. With reference again to step 918, if the user does not select a title from the list, the process then initiates the connection with the named user without pulling up any saved conversation.

With reference again to step 910, if a title was not found, the process then displays a no title message (step 924). This message indicates that no titles matching the name were found for saved conversations. Thereafter, the process proceeds to step 922 as described above.

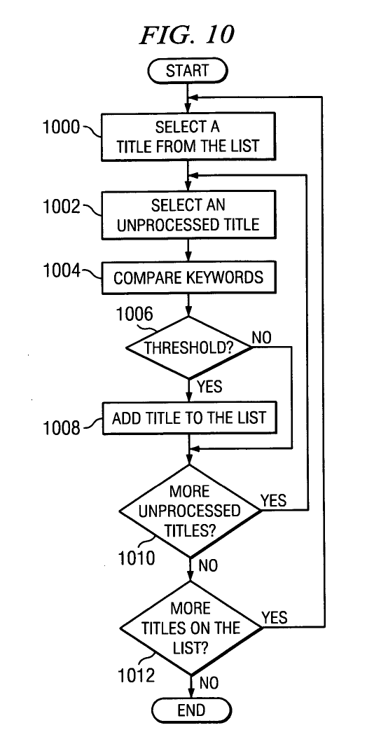

Turning now to FIG. 10, a flowchart of a process for identifying additional conversations for use is depicted in accordance with an illustrative embodiment of the present invention. The process illustrated in FIG. 10 may be implemented in a process, such as conversation archive and retrieval process 408 in FIG. 4.

The process begins by selecting a title from the list (step 1000). This list is a list generated by the process illustrated in FIG. 9. Thereafter, an unprocessed title is selected from the titles saved for conversation (step 1002). The process then compares keywords (step 1004) and a determination is made as to whether some threshold is met (step 1006). This threshold in these examples is if some number of keywords from the title on the list matches the one selected for processing. If a match is present, the process adds the title to the list (step 1008).

Next, a determination is made as to whether additional unprocessed titles are present (step 1010). The process proceeds directly to step 1010 from step 1006 is the threshold is not met. If additional unprocessed titles are present, the process returns to step 1002 to select another unprocessed title. Otherwise, a determination is made as to whether additional titles are present on the list for processing (step 1012). If additional titles are present on the list, the process returns to step 1000. Otherwise, the process terminates. The process illustrated in FIG. 10 may be implemented in conjunction with the process in FIG. 9 as a second order search to identify more titles for presentation in step 912 in FIG. 9.

Thus, the aspects of the present invention provide a computer implemented method, apparatus, and computer usable program code for managing conversation in which data from the conversations are extracted to form an abstract and stored in association with the conversation. This abstract may take various forms, such as keywords and end points or even a title generated from the conversation. When a conversation is started, the name of the person for which the conversation is to be initiated is looked up within the end points in the saved data. A menu of past conversations is listed by title allowing the user to select one of these titles. In response to selecting the title, the contents of that previous conversation are placed into a window for display. Thereafter, the connection with the person selected is initiated.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing conversations, the computer implemented method comprising:
detecting an indication that a conversation between a users in an instant messaging system should be saved;
responsive to detecting the indication, extracting endpoints and keyword data from the conversation;
generating an abstract from the endpoints and the keyword data; and
storing the conversation in association with the abstract.

2. The computer implemented method of claim 1 further comprising:
responsive to an identification of a name of a user for a new conversation, identifying each abstract from a plurality of abstracts containing the name of the user as an endpoint to form a list;
presenting the list; and
responsive to a selection of a selected abstract from the list, displaying a saved conversation associated with the selected abstract.

3. The computer implemented method of claim 1 further comprising:
responsive to an input of a string, searching a plurality of abstracts for an occurrence of the string;
placing each abstract having a match to the string in a list; and
presenting the list.

4. The computer implemented method of claim 1, wherein the extracting step comprises:
identifying each user to the conversation to from the endpoints;
comparing text in the conversation with a dictionary; and
identifying keyword data from matches between text in the conversation and entries in the dictionary.

5. The computer implemented method of claim 4, wherein the dictionary is at least one of a user dictionary of terms and a technical dictionary.

6. The computer implemented method of claim 4, wherein the step of identifying keyword data from matches between text in the conversation and entries in the dictionary comprises identifying a number of times a particular term in text having a match in the dictionary occurs in the conversation.

7. The computer implemented method of claim 2, wherein the presenting step comprises:
displaying the endpoints and keyword data for each abstract on the list.

8. The computer implemented method of claim 1, wherein the abstract is a title generated from the endpoints and keyword data.

9. The computer implemented method of claim 1, wherein the abstract is endpoints and the keyword data.

10. A computer program product comprising:
a computer usable medium having computer usable program code for managing conversations, the computer program product including:
computer usable program code for detecting an indication that a conversation between a users in an instant messaging system should be saved;
computer usable program code, responsive to detecting the indication, for extracting endpoints and keyword data from the conversation;
computer usable program code for generating an abstract from the endpoints and the keyword data; and
computer usable program code for storing the conversation in association with the abstract.

11. The computer program product of claim 10 further comprising:
computer usable program code, responsive to an identification of a name of a user for a new conversation, for identifying each abstract from a plurality of abstracts containing the name of the user as an endpoint to form a list;
computer usable program code for presenting the list; and
computer usable program code, responsive to a selection of a selected abstract from the list, for displaying a saved conversation associated with the selected abstract.

12. The computer program product of claim 10 further comprising:
computer usable program code, responsive to an input of a string, for searching a plurality of abstracts for an occurrence of the string;
computer usable program code for placing each abstract having a match to the string in a list; and
computer usable program code for presenting the list.

13. The computer program product of claim 10, wherein the computer usable program code for extracting endpoints and keyword data from the conversation in response to detecting the indication comprises:
computer usable program code for identifying each user to the conversation to from the endpoints;
computer usable program code for comparing text in the conversation with a dictionary; and
computer usable program code for identifying keyword data from matches between text in the conversation and entries in the dictionary.

14. The computer program product of claim 13, wherein the dictionary is at least one of a user dictionary of terms and a technical dictionary.

15. The computer program product of claim 13, wherein computer usable program code for identifying keyword data from matches between text in the conversation and entries in the dictionary comprises identifying a number of times a particular term in text having a match in the dictionary occurs in the conversation.

16. The computer program product of claim 11, wherein the computer usable program code for presenting the list comprises:
computer usable program code for displaying the endpoints and keyword data for each abstract on the list.

17. The computer program product of claim 10, wherein the abstract is a title generated from the endpoints and keyword data.

18. The computer program product of claim 10, wherein the abstract is endpoints and the keyword data.

19. A data processing system comprising:
a bus;
a communications unit connected to the bus;
a memory connected to the bus, wherein the storage device includes a set of computer usable program code; and
a processor unit connected to the bus, wherein the processor unit executes the set of computer usable program code to detect an indication that a conversation between a users in an instant messaging system should be saved; extract endpoints and keyword data from the conversation in response to detecting the indication; generate an abstract from the endpoints and the keyword data; and store the conversation in association with the abstract.

20. A data processing system for managing conversations, the data processing system comprising:
detecting means for detecting an indication that a conversation between a users in an instant messaging system should be saved;
extracting means, responsive to detecting the indication, for extracting endpoints and keyword data from the conversation;
generating means for generating an abstract from the endpoints and keyword data; and
storing means for storing the conversation in association with the abstract.
